(19) United States
(12) Patent Application Publication
(10) Pub. No.: US 2021/0294307 A1
(43) Pub. Date: Sep. 23, 2021

(54) ASSISTED ENGINEERING DESIGN AND DEVELOPMENT MANAGEMENT SYSTEM

(71) Applicant: Honeywell International Inc., Morris Plains, NJ (US)

(72) Inventors: Sivanarayana Onteddu, Chalfont, PA (US); Senthilkumar Dhanagopalan, Bangalore (IN); Rajendra Bandekar, Ambler, PA (US)

(21) Appl. No.: 16/824,254

(22) Filed: Mar. 19, 2020

(51) Int. Cl. G05B 19/418

(52) U.S. Cl. CPC G05B 19/4188; G05B 2219/31342

(57) ABSTRACT

Methods and systems for engineering design and management, can include constructing an engineering workflow development environment into an industrial automation control system, wherein the engineering workflow development environment speeds-up and manages engineering design and development activities and one or more phases with respect to the industrial automation control system. A workflow engine can operate within the engineering workflow development environment, wherein the workflow engine allows a user to track and modify the status of any of the phases.

### TECHNICAL FIELD

Embodiments are generally related to the field of engineering design and development management systems. Embodiments also relate to engineering design and development management systems, tools and methods used for industrial automation control systems.

### BACKGROUND

Complexity in advanced process control system engineering design and development is steadily increasing due to growth in the number of system functions, complex inter-dependencies, frequent engineering change requests, and the amount of engineering data generated by the process control system. Because of this, project engineering development durations can substantially increase, which can further delay (end-to-end speed) the time-to-make new products.

In a typical industrial process control system involving engineering development with several project engineers in parallel and iterative engineering design and associated functions development, many problems may arise from the lack of control over engineering data, and the engineering development workflow including engineering change management.

Current manual engineering data control and data management practices in the process manufacturing industry have resulted in a bottleneck of support for engineering activities that consistently track the engineering development stages against product specifications. In parallel and iterative project engineering development with cross-functional teams, for example, existing practices are not efficient in identifying the development state of engineering data that are in implementation, completed, and validated phases. Project Engineers typically use multiple tools (e.g., Microsoft Office spreadsheets, PowerPoint, etc.) to track the project engineering data development phases and change requests.

Transformation of engineering input data from design specifications into an engineering output configuration database through various engineering activities does not provide a view holistically across a subset of system functions, which means that activities may not be planned effectively by the project engineers participating in the engineering. Complex interdependencies between subsystem functions involved in the project engineering may not be managed efficiently to assist project engineers in design specifications that are completed in the engineering implementation and validation phases.

Solutions are needed to fix the engineering configuration against design specification changes and changes to the interdependent engineering configuration. Frequent engineering design changes and a high degree of uncertainty in the early project engineering phases may lead to ad-hoc technical decisions and an increase in time and effort to introduce a change into an existing engineering configuration.

These challenges in existing project engineering development and management practices for engineering activities may result in inefficient and time-consuming operational overhead in product development, which in turn can increase capital costs and lead to reductions in the overall quality assurance.

### BRIEF SUMMARY

The following summary is provided to facilitate an understanding of some of the features of the disclosed embodiments and is not intended to be a full description. A full appreciation of the various aspects of the embodiments disclosed herein can be gained by taking the specification, claims, drawings, and abstract as a whole.

It is, therefore, one aspect of the disclosed embodiments to provide for improved engineering design and development management methods and systems.

It is another aspect of the disclosed embodiments to provide for assisted engineering design and development management methods and systems for industrial distributed automation control.

It is yet another aspect of the disclosed embodiments for provide for an efficient engineering workflow development environment built-in to an industrial automation control system to speed-up and manage project engineering design and development activities.

The aforementioned aspects and other objectives can now be achieved as described herein. In an embodiment, a method for engineering design and management, can involve: constructing an engineering workflow development environment into an industrial automation control system, wherein the engineering workflow development environment speeds-up and manages engineering design and development activities and a plurality of phases with respect to the industrial automation control system; and operating a workflow engine within the engineering workflow development environment, wherein the workflow engine allows a user to track and modify the status of any phase among the plurality of phases.

In an embodiment of the method, the plurality of phases can comprise a phase involving a design specification tool.

In an embodiment of the method, the plurality of phases can comprise a phase involving project engineering management.

In an embodiment of the method, the plurality of phases can comprise a phase involving constructing the engineering workflow development environment.

In an embodiment of the method, the plurality of phases can comprise a phase involving interdependency assistance.

In an embodiment of the method, the plurality of phases can comprise a phase involving reviewing and tracking engineering development of the engineering workflow development environment through a human machine interface.

In an embodiment of the method, the human machine interface is operable to permit the user to view information from the design specification tool and execution of the engineering workflow development environment.

In another embodiment, a system for engineering design and management, can include: an industrial automation control system having an engineering workflow development environment constructed into the industrial automation control system, wherein the engineering workflow development environment speeds-up and manages engineering design and development activities and a plurality of phases with respect to the industrial automation control system; and a workflow engine operable within the engineering workflow development environment, wherein the workflow engine allows a user to track and modify the status of any phase among the plurality of phases.

In another embodiment, a system for engineering design and management, can include at least one processor, and a non-transitory computer-usable medium embodying computer program code. The computer-usable medium is capable of communicating with the at least one processor. The computer program code can include instructions executable by the at least one processor and configured for: constructing an engineering workflow development environment into an industrial automation control system, wherein the engineering workflow development environment speeds-up and manages engineering design and development activities and a plurality of phases with respect to the industrial automation control system; and operating a workflow engine within the engineering workflow development environment, wherein the workflow engine allows a user to track and modify the status of any phase among the plurality of phases.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a system that includes an assisted engineering development management system and a distributed engineering tools and repository in accordance with an embodiment;

FIG. 2 illustrates a development workflow strategy that can be implemented in accordance with an embodiment;

FIG. 3 illustrates an engineering qualification workflow strategy that can be implemented in accordance with an embodiment;

FIG. 4 illustrates an engineering software design specification workflow in accordance with an embodiment;

FIG. 5 illustrates a schematic view of a data-processing system, in accordance with an embodiment; and

FIG. 6 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other issues, subject matter may be embodied as methods, devices, components, or systems. Accordingly, embodiments may, for example, take the form of hardware, software, firmware, or a combination thereof. The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein may not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Generally, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

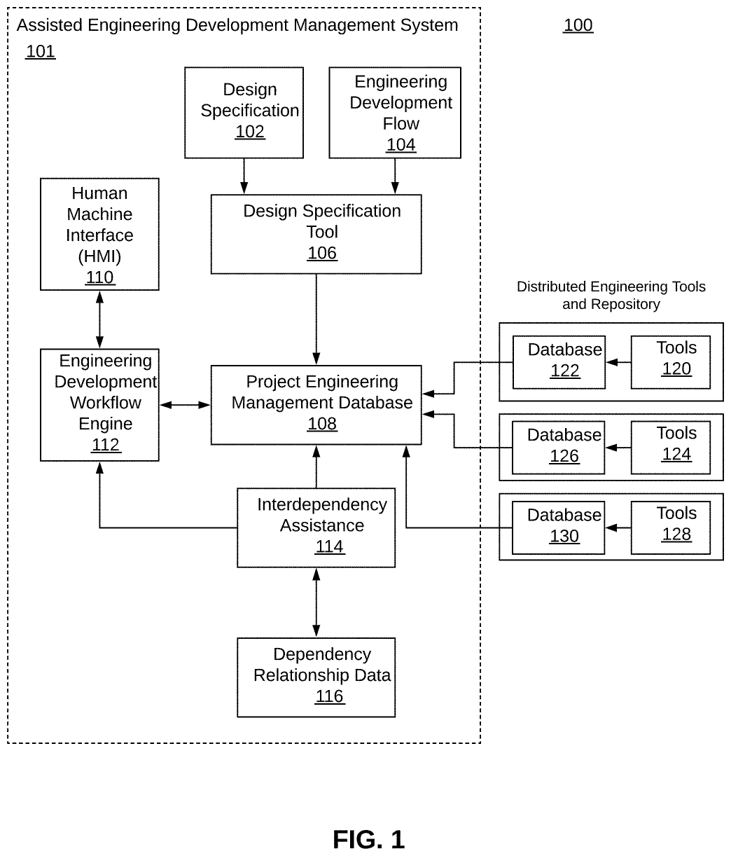

FIG. 1 illustrates a block diagram of a system 100 that includes an assisted engineering development management system 101 and a distributed engineering tools and repository, in accordance with an embodiment. The assisted engineering development management system 101 includes a human machine interface (HMI) 110 that can communicate bidirectionally with an engineering development workflow engine 112.

A design specification 102 and an engineering development flow 104 can provide data to a design specification tool 106, which in turn can provide data to a project engineering management database 108. An interdependency assistance service module 114 can also provide data to the project engineering management database 108. The interdependency assistance service module 114 can also receive data from a dependency relationship data module 116. The interdependency assistance service module 114 can provide data to the engineering development workflow engine 112 for processing.

The distributed engineering tools and repository generally includes an engineering database 122 and engineering tools 120. The distributed engineering tools and repository can further include an engineering database 126 and engineering tools 124, and an engineering database 130 and engineering tools 128.

The design specification tool 106 can define the design specification 102 based on user requirements and functional specifications, tag naming convention, and engineering development task strategies. The project engineering management database 108 can store the design specifications, engineering development flow definition, and dependency relationship data 116 collected from actual engineering data (e.g., asset, control strategies, process graphics) created using distributed engineering tools such as, for example the engineering tools 120, the engineering tools 124 and/or the engineering tools 128.

The engineering development workflow engine 112 can execute the engineering development strategies and show the progress and status of the different activities in engineering development using color-coding and tags associated with the activities executed in each development steps. The interdependency assistance service module 114 can maintain the relationship between user-defined specification and engineering configuration and interdependencies between the engineering configuration using dependency relationship data 116. The HMI 110 can be used to view the information from the design specification tool 106 and engineering development execution.

Step 1. A first step can involve the development of an engineering workflow. After a successful initial inspection and approval of all the released project master software design specifications by project management, a project engineer can add the details of a software design specification including inputs, tag naming convention, and loop typical using the design specification tool 106. By using the design specification tool 106, the project engineer can build the engineering development workflow strategies using development steps where each development step represents the engineering activities of selected tags.

The project engineering can create multiple development execution strategies to track the development separately if needed. This approach can enable the creation of the development process sequence (e.g., parallel, sequence, iterative, alternative) by designing the workflow. The development workflow strategy can execute at user-defined development periods of, for example, a minimum of 1 minute to a maximum of 24 hours. The development workflow strategies can be maintained and managed through version control. Also, the design specification tool 106 can be used to assign each step to project engineers participate in the engineering development effort.

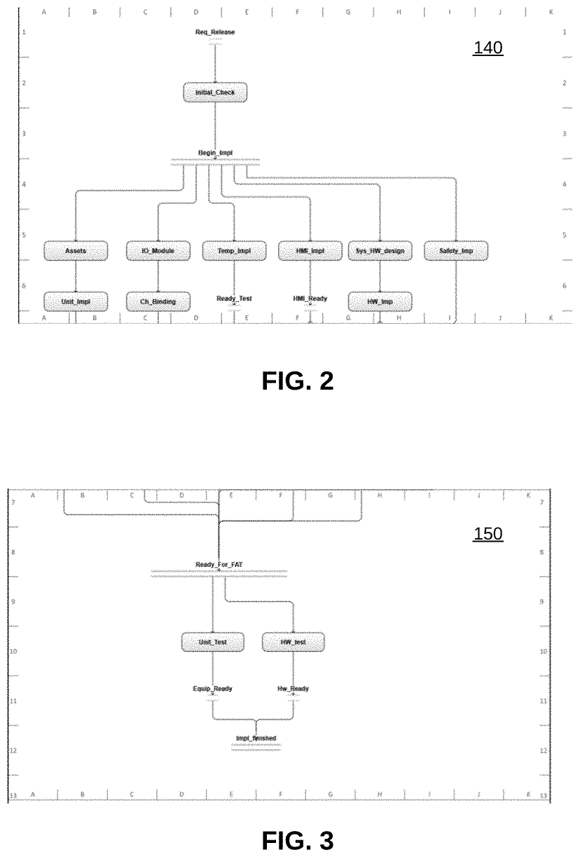

FIG. 2 illustrates a development workflow strategy 140 that can be implemented in accordance with an embodiment. FIG. 3 illustrates an engineering qualification workflow strategy 150 that can be implemented in accordance with an embodiment. After successful implementation, all the objects can be qualified against the specifications. In the software, Factory Acceptance Test (FAT) of the design objects can be tested.

Step 2. A second step can involve engineering configuration development and review. Based on the assigned tasks, a project engineer can build the software module in the distributed engineering tools. The software module implementation for the individual control strategies, sequential control strategies and process graphics can be tested against the software design specification.

Step 3. A third step can involve an engineering development workflow execution. The development workflow strategy can execute in the engineering development workflow engine 112 to monitor the following: while the engineering data developed in the distributed engineering tools 120, 124, and 128 using the user-defined tags, the engineering development workflow engine 112 can monitor the progress of tags associated in each step and obtain the information from user defined process control system supported subsystem types (e.g., process points, SCADA, HMI displays, etc) to get the relationship and interdependencies based on the tag name from interdependency assistance service module 114.

Note that the term SCADA as utilized herein refers to an acronym for Supervisory Control and Data Acquisition, which can be implemented as a computer system for gathering and analyzing real time data. SCADA systems can be used to monitor and control a plant or equipment in industries such as telecommunications, water and waste control, energy, oil and gas refining, pharmaceuticals and transportation.

If the user did not define the process control system supported subsystem function in the development workflow step, the execution can automatically track all the applicable subsystems of the control system in which the tag was implemented and show the status if the tag is completed implemented and qualified.

The development step can show the list of tags configured in the development workflow step and the subsystems in which the tag was implemented and its status based on the user-defined completion criteria. The user can define the tag completion criteria based on qualification state, loaded to a server and a controller, and active in the controller for executions status. The information can also include the user information including who created and qualified the tag.

The user can then select a block to extract the information of tags defined in the block. Also, based on the engineering data, a development management execution can show the following status indicators for development step blocks: Not started, In progress, Implemented, Qualified, Transfer and Blocked. At each development step level, the user can define the planned engineering effort and the block will calculate the effort based on the time it took to reach the defined completion criteria. This can provide the ability to show the effort spent in each step with a possible reason for delay.

For any change in specifications (e.g., change requests), the project engineer can update the tags in each development step and define the process control subsystem database (e.g., Control Builder, SCADA, HMI, SM) to implement the tags. Also, the development tool can enable adding/deleting the development steps at any time during product development execution based on the change.

The development workflow strategy can monitor any changes to the tag in the control system subsystem and can enable the configuration of a step that requires change management. For example, with any changes to the tag name in any subsystem, the development workflow step can indicate the new changes. In another example, for a change request, the user can select the tags of the blocks that require change management and the block can indicate the change management process.

Using the interdependency assistance service module 114, the engineering development workflow engine 112 can show the interdependent relationship of tags in the hierarchy, version criteria, and variant names used in the system. For example, If the tag is a master recipe type, it will show the procedure hierarchy and its relationship to units and equipment. If the tag is an I/O, it will show a relationship to the CM and channel and IOM and Controller hierarchy. Similarly, if the tag is used to define a software template, the relationship view can show the view from template to sub-template, instances and instance references used within and across the subsystems.

The interdependency assistance service module 114 can maintain the relationship and interdependencies between the modules using dependency relationship data and aid in reconfiguring the interdependent engineering data based on the changes. For example, for any alternate name change, the tool can assist in identifying the affected engineering reports and operational displays to fix the configuration change quickly. Once the project development is completed, the user can stop the engineering development workflow engine 112 from monitoring the engineering data changes. To track any future changes, the user can resume the execution to execute the block configuration and show the impact of changes across the subsystems.

The disclosed embodiments can provide users with a greater understanding and control through real-time and continuous monitoring for efficient project engineering, which in turn can speed up the engineering involved in a new product development. The disclosed embodiments can support a number of capabilities for flexible product development and maintenance. For example, the disclosed embodiments can provide an efficient engineering development workflow based on engineering activities that can generate the engineering data, the work of project engineers who perform engineering activities, and the engineering data across the product life cycle. In addition, the disclosed approach can provide an up-to-date engineering data configuration life-cycle status (e.g., in-progress, not-started, implemented, completed, validated, etc.) across the distributed engineering tools and engineering data repositories.

The disclosed solution can also provide a view for the engineering development status for the iterative/phased product development, which may include many parallel activities with a mutual relation between interdependent objects (e.g., control strategies, process graphics, Assets, etc.). This approach can also enforce and maintain consistency of the engineering workflow and configuration data shared across distributed engineering tools used in project engineering development, and can further provide for flexibility to change engineering workflow and configuration of an existing engineering data based on the engineering data change management. Additionally, the disclosed embodiments can be implemented to track the product specifications/requirements into specific engineering data objects along with associated subsystems (e.g., process points, SCADA, process graphics, etc.) of the distributed process control system.

The disclosed approach can further enable consistency and flexibility in engineering design and development activities that create and use the engineering data generated across distributed engineering tools of the control system and stored in distributed engineering data repositories. In addition, the disclosed embodiments can provide an up-to-date view of engineering development workflow while maintaining the configuration control and traceability. The disclosed embodiments can also facilitate managing engineering activities implemented and used across distributed engineering tools and data repositories that show the engineering data hierarchy based on configuration integrated and implemented in the engineering tools, including industry standard procedures, and physical models, version information, and template-based implementation.

The disclosed approach can be further implemented to show the engineering data development workflow to quickly understand the current product development life cycle state, and also provide an engineering development workflow starting from an initial concept to a released product to manufacturing and maintenance. The disclosed embodiments can further provide a validation status of engineering configuration for regulatory compliance and an audit trail. The disclosed embodiments can further aid in re-engineering and re-validation of affected engineering data configurations through an automatic notification to related and interdependent configurations for effective change management. Finally, this approach can assist in engineering design and development to quickly fix configuration changes and modifications based on the engineering data changes.

The disclosed embodiments can offer advantages to, for example, a process control system engineering organization. For example, by implementing the disclosed embodiments, the product development cycle can be reduced during the development and validation of the engineering configuration. Cost reductions can also be achieved through effective change management that can generate bottom-line savings and business opportunity costs. In addition, project engineering resource utilization can be improved to support additional project development. In addition, new product developments may be delivered with payment milestones, and product engineering consistency and overall product quality assurance can be improved. Paperwork and manual effort may also be reduced through automatic report generation of project engineering design and development activities.

The disclosed embodiments also offer advantages to customers of the project engineering process. For example, the disclosed approach can reduce the cost and time it make take to introduce new products and product expansions through an increase in engineering data understanding and ensuring that information is captured in a manner that can support future manufacturing and investigational requirements. The disclosed approach can further improve the quality of products and services offered by allowing for the collation of all data that may be needed to make rapid release decisions. Without this, progress gained from advanced data collection and rapid analytics may still be bottlenecked by data collation delays. The disclosed approach can also reduce the maintenance and troubleshooting effort by offering a greater understanding and control through real-time and continuous monitoring of engineering development and changes.

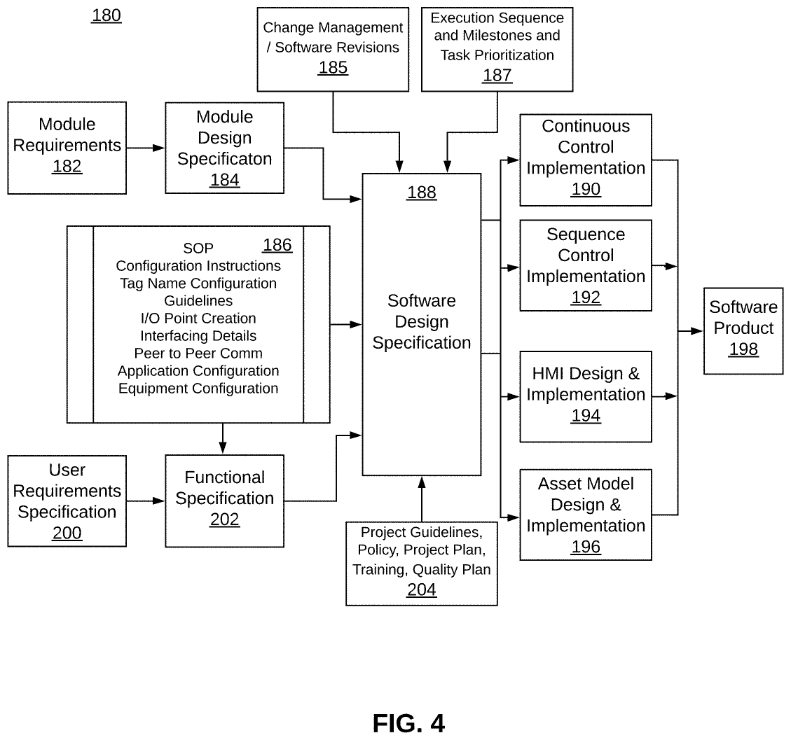

FIG. 4 illustrates an engineering software design specification workflow 180 in accordance with an embodiment. The engineering software design specification workflow 180 shown in FIG. 4 can include modules requirements 182, which can be provided as input to a module design specification 184. Data and instructions provided by the module design specification 184 can be input to a software design specification 188. Additional parameters 186 can also be provided to the software design specification 188. These additional parameters can include can include, for example, factors such as the Safe Operating Procedure (SOP), a tag name configuration, guidelines, I/O point creation, interfacing details, data regarding peer to peer communication, application configuration, and equipment configuration.

A user requirements specification (URS) 200 can also be provided to a functional specification (FS) 202, which in turn can be provided as input to the software design specification 188. Other parameters may also be provided as input to the software design specification (SDS) 188, such as, for example, project guidelines, policy information, project plan data, training information, and quality plan information, as shown at block 204. Revisions 185 such as change management and/or software revisions can also be input to the SDS 188. Furthermore, data and instructions regarding execution sequence and milestones and task prioritization, as depicted at block 187 can also be provided as input to the SDS 188.

Output from the SDS 188 can include continuous control implementation 190, sequence control implementation 192, HMI design and implementation 194, and asset model design and implementation 196. Output or results from the control implementation 190, the sequence control implementation 192, the HMI design and implementation 194, and the asset model design and implementation 196, can contribute to the configuration of the software product 198.

The user requirements specification (URS) 200 can be written by a customer. This document can include all system requirements as defined by the customer. The customer can be responsible for performing a risk assessment on any individual requirement to determine whether it is Good Manufacturing Practice (GMP) critical. The URS can be transmitted to a supplier for analysis.

In response to the URS 200, the Functional Specification (FS) 202 can be written by the supplier, for example, to fulfill the requirements of the URS 200. Module design specifications in the workflow 180 may require several tasks. For example, some requirements of the URS 200 may only be accomplished by building Custom Software Applications (SW Modules). For each SW Module, a design specification can be created. The SDS 188 can possess sufficient detail so that a software development engineer can develop the subjected software module (i.e., the software product 198). Together with the SDS 188, a Software Test Specification (STS) will be created. The STS can be used in a later stage for black box testing. The scope is to check whether the SW module has been completely developed as designed in the SDS 188.

As can be appreciated by one skilled in the art, embodiments can be implemented in the context of a method, a system, and data processing systems or computer program products. Accordingly, embodiments may take the form of an entirely hardware embodiment, an entirely software embodiment or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a bidirectional data communications network such as a local area network (LAN) or a wide area network (WAN), a wireless local area network (WLAN), wireless data network e.g., Wi-Fi, Wimax, 802.xx, and/or a cellular network or the bidirectional connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block or feature of the illustrations, and combinations of blocks or features, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks or elsewhere herein. To be clear, the disclosed embodiments can be implemented in the context of, for example a special-purpose computer or a general-purpose computer, or other programmable data processing apparatus or system. For example, in some embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which can comprise one or more executable instructions for implementing the specified logical function(s). In some alternative implementations, the functions noted in the block may occur out of the order noted in the figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that can perform the specified functions or acts or carry out combinations of special purpose hardware and computer instructions.

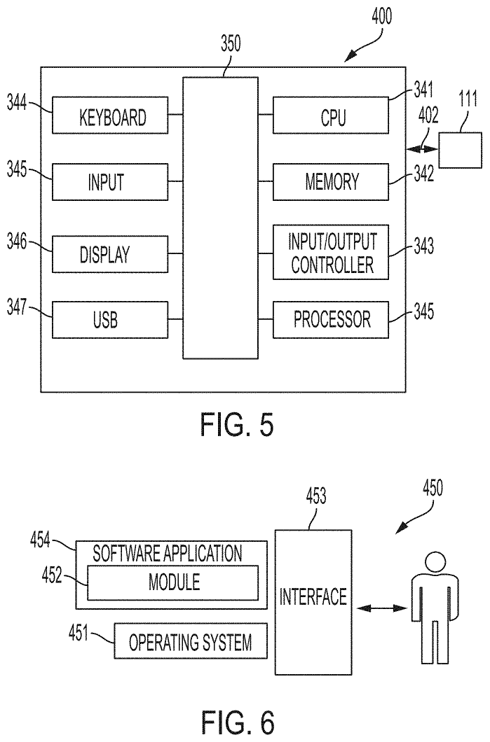

FIG. 5 and FIG. 6 are shown only as exemplary diagrams of data-processing environments in which example embodiments may be implemented. It should be appreciated that FIG. 5 and FIG. 6 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 5, some embodiments may be implemented in the context of a data-processing system 400 that can include, for example, one or more processors such as a CPU (Central Processing Unit) 341 and/or other another processor 349 (e.g., microprocessor, microcontroller etc), a memory 342, an input/output controller 343, a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc) and/or other peripheral connections and components.

As illustrated, the various components of data-processing system 400 can communicate electronically through a system bus 351 or similar architecture. The system bus 351 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server).

In some example embodiments, data-processing system 400 may be, for example, a standalone desktop computer, a laptop computer, a smartphone, a tablet computing device, a networked computer server, and so on, wherein each such device can be operably connected to and/or in communication with a client-server based network or other types of networks (e.g., cellular networks, Wi-Fi, etc). The data-processing system 400 can communicate with other devices such as, for example, an electronic device 111 (e.g., a peripheral device such as a printer, a sensor, a camera, etc.). Communication between the data-processing system 400 and the electronic device 111 can be bidirectional, as indicated by the double arrow 402. Such bidirectional communications may be facilitated by, for example, a computer network, including wireless bidirectional data communications networks.

FIG. 6 illustrates a computer software system 450 for directing the operation of the data-processing system 400 depicted in FIG. 5. Software application 454, stored for example in the memory 342 can include one or more modules such as module 452. The computer software system 450 also can include a kernel or operating system 451 and a shell or interface 453. An example of the shell or interface 453 is the HMI 110 discussed previously with respect to FIG. 1. Another example of the shell or interface 452 is a GUI (Graphical User Interface). The HMI 110 may function as or include a GUI.

One or more application programs, such as software application 454, may be “loaded” (i.e., transferred from, for example, mass storage or another memory location into the memory 342) for execution by the data-processing system 400. The data-processing system 400 can receive user commands and data through the interface 453; these inputs may then be acted upon by the data-processing system 400 in accordance with instructions from operating system 451 and/or software application 454. The interface 453 in some embodiments can serve to display results, whereupon a user (e.g., such as shown at the right hand side of FIG. 6) may supply additional inputs or terminate a session. The software application 454 can include module(s) 452, which can, for example, implement instructions, steps or operations such as those discussed herein. Module 452 may also be composed of a group of modules and/or sub-modules.

The following discussion is intended to provide a brief, general description of suitable computing environments in which the system and method may be implemented. The disclosed embodiments can be described in the general context of computer-executable instructions, such as program modules, being executed by a single computer. In most instances, a “module” can constitute a software application, but can also be implemented as both software and hardware (i.e., a combination of software and hardware), and/or in concert and communication with physical electronic devices such as sensors.

Generally, program modules include, but are not limited to, routines, subroutines, software applications, programs, objects, components, data structures, etc., that can perform particular tasks or which can implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which may be private (e.g., accessible only to that module) and which can include source code that actually implements the routines in the module. The term module can also relate to an application, such as a computer program designed to assist in the performance of a specific task, such as implementing the operations previously discussed herein. Each block shown in the various figures herein can in some embodiments comprise a module.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for engineering design and management, comprising:
constructing an engineering workflow development environment into an industrial automation control system, wherein the engineering workflow development environment speeds-up and manages engineering design and development activities and a plurality of phases with respect to the industrial automation control system; and
operating a workflow engine within the engineering workflow development environment, wherein the workflow engine allows a user to track and modify the status of any phase among the plurality of phases.

2. The method of claim 1 wherein the plurality of phases comprises a phase involving a design specification tool.

3. The method of claim 1 wherein the plurality of phases comprises a phase involving project engineering management.

4. The method of claim 1 wherein the plurality of phases comprises a phase involving the workflow engine for constructing the engineering workflow development environment.

5. The method of claim 1 wherein the plurality of phases comprises a phase involving interdependency assistance.

6. The method of claim 2 wherein the plurality of phases comprises a phase involving reviewing and tracking engineering development of the engineering workflow development environment through a human machine interface.

7. The method of claim 6 wherein the human machine interface is operable to permit the user to view information from the design specification tool and execution of the engineering workflow development environment.

8. A system for engineering design and management, comprising:
an industrial automation control system having an engineering workflow development environment constructed into the industrial automation control system, wherein the engineering workflow development environment speeds-up and manages engineering design and development activities and a plurality of phases with respect to the industrial automation control system; and
a workflow engine operable within the engineering workflow development environment, wherein the workflow engine allows a user to track and modify the status of any phase among the plurality of phases.

9. The system of claim 8 wherein the plurality of phases comprises a phase involving a design specification tool.

10. The system of claim 8 wherein the plurality of phases comprises a phase involving project engineering management.

11. The system of claim 8 wherein the plurality of phases comprises a phase involving the workflow engine for constructing the engineering workflow development environment.

12. The system of claim 8 wherein the plurality of phases comprises a phase involving interdependency assistance.

13. The system of claim 9 wherein the plurality of phases comprises a phase involving reviewing and tracking engineering development of the engineering workflow development environment through a human machine interface.

14. A system for engineering design and management, comprising:
at least one processor; and
a non-transitory computer-usable medium embodying computer program code, the computer-usable medium operable to communicate with the at least one processor, the computer program code comprising instructions executable by the at least one processor and configured for:
constructing an engineering workflow development environment into an industrial automation control system, wherein the engineering workflow development environment speeds-up and manages engineering design and development activities and a plurality of phases with respect to the industrial automation control system; and
operating a workflow engine within the engineering workflow development environment, wherein the workflow engine allows a user to track and modify the status of any phase among the plurality of phases.

15. The system of claim 14 wherein the plurality of phases comprises a phase involving a design specification tool.

16. The system of claim 14 wherein the plurality of phases comprises a phase involving project engineering management.

17. The system of claim 14 wherein the plurality of phases comprises a phase involving the workflow engine for constructing the engineering workflow development environment.

18. The system of claim 14 wherein the plurality of phases comprises a phase involving interdependency assistance.

19. The system of claim 15 wherein the plurality of phases comprises a phase involving reviewing and tracking engineering development of the engineering workflow development environment through a human machine interface.

20. The system of claim 19 wherein the human machine interface is operable to permit the user to view information from the design specification tool and execution of the engineering workflow development environment.
